(19) United States
(12) Patent Application Publication
(10) Pub. No.: US 2025/0375758 A1
(43) Pub. Date: Dec. 11, 2025

(54) AMMONIA SYNTHESIS CATALYST, METHOD FOR PRODUCING THE SAME, AND METHOD FOR SYNTHESIZING AMMONIA USING THE SAME

(71) Applicants: KABUSHIKI KAISHA TOYOTA CHUO KENKYUSHO, Nagakute-shi, Aichi (JP); TOYOTA JIDOSHA KABUSHIKI KAISHA, Toyota-shi, Aichi (JP); NATIONAL INSTITUTE OF ADVANCED INDUSTRIAL SCIENCE AND TECHNOLOGY, Tokyo (JP)

(72) Inventors: Kiyoshi YAMAZAKI, Nagakute-shi (JP); Yoshihiro GOTO, Nagakute-shi (JP); Masashi KIKUGAWA, Nagakute-shi (JP); Marie ISHIKAWA, Nagoya-shi (JP); Akinori SATOU, Mishima-shi (JP); Yuichi MANAKA, Tsukuba-shi (JP); Tetsuya NANBA, Tsukuba-shi (JP); Hideyuki MATSUMOTO, Tokyo (JP)

(73) Assignees: KABUSHIKI KAISHA TOYOTA CHUO KENKYUSHO, Nagakute-shi, Aichi (JP); TOYOTA JIDOSHA KABUSHIKI KAISHA, Toyota-shi, Aichi (JP); NATIONAL INSTITUTE OF ADVANCED INDUSTRIAL SCIENCE AND TECHNOLOGY, Tokyo (JP)

(21) Appl. No.: 18/875,277

(22) PCT Filed: Jun. 28, 2023
(86) PCT No.: PCT/JP2023/023956

§ 371 Date: Dec. 16, 2024

(30) Foreign Application Priority Data
Jun. 28, 2022 (JP) 2022-103682
Mar. 23, 2023 (JP) 2023-047302

(51) Int. Cl. B01J 23/63; B01J 23/10; B01J 35/61; B01J 35/63; B01J 35/64; B01J 37/00; B01J 37/02; C01C 1/04

(52) U.S. Cl. CPC B01J 23/63; B01J 23/10; B01J 35/613; B01J 35/633; B01J 35/635; B01J 35/638; B01J 35/647; B01J 37/0009; B01J 37/0207; C01C 1/0411

(57) ABSTRACT

An ammonia synthesis catalyst including a catalyst support including cerium oxide and ruthenium supported on the catalyst support, wherein a peak pore diameter is in a range of 8 to 16 nm, and a pore volume in a pore diameter range of 10 to 16 nm is 0.10 cm³/g or more, and/or a pore volume in a pore diameter range of 8 to 20 nm is 0.16 cm³/g or more, as measured by a Barrett-Joyner-Halenda (BJH) method.

### TECHNICAL FIELD

The present invention relates to an ammonia synthesis catalyst, a method for producing the same, and a method for synthesizing ammonia using the same; more specifically, it relates to an ammonia synthesis catalyst comprising a catalyst support including cerium oxide and ruthenium supported on the catalyst support, a method for producing the same, and a method for synthesizing ammonia using the same.

### BACKGROUND ART

In recent years, ammonia has been attracting attention as a component that can be applied to uses such as an energy carrier for hydrogen energy. As a method for synthesizing such ammonia, the Haber-Bosch process using an iron-based catalyst as a catalyst has been industrially used conventionally; however, in recent years, research on various types of ammonia synthesis catalysts has been advanced aiming to synthesize ammonia under milder conditions than the Haber-Bosch process.

For example, Japanese Unexamined Patent Application Publication No. 2021-109130 (PTL 1) discloses a Ru catalyst supported on CeO₂ for synthesizing ammonia from nitrogen and hydrogen, in which the BET surface area of the CeO₂ support is in the range of 17 to 100 m²/g and the pore volume is in the range of 0.09 to 0.25 ml/g; it also discloses a method for producing a Ru catalyst supported on CeO₂, comprising preparing CeO₂ by calcining a precipitate obtained by adding a KOH aqueous solution or an ammonia solution as a precipitant to a cerium nitrate aqueous solution, impregnating the CeO₂ with Ru(NO)(NO₃)₃ to support Ru, and then performing hydrogen treatment.

Furthermore, Journal of Rare Earths, 2019, Vol. 37, pp. 492-499 (NPL 1) discloses that Ru-supported La₂Ce₂O₇ was prepared by reacting lanthanum oxide with nitric acid, adding diammonium cerium nitrate, further adding citric acid, followed by removing the solvent, drying, and calcining.

### CITATION LIST

### Patent Literature

[PTL 1] Japanese Unexamined Patent Application Publication No. 2021-109130

### Non Patent Literature

[NPL 1] Journal of Rare Earths, 2019, Vol. 37, pp. 492-499

### SUMMARY OF INVENTION

### Technical Problem

However, the Ru catalyst supported on CeO₂ described in PTL 1 and the Ru-supported La₂Ce₂O₇ described in NPL 1 do not have sufficiently high ammonia synthesis activity.

The present invention has been made in view of the problems of the related art, and an object thereof is to provide an ammonia synthesis catalyst excellent in ammonia synthesis activity and a method for producing the same, as well as a method for synthesizing ammonia capable of efficiently synthesizing ammonia from hydrogen and nitrogen.

### Solution to Problem

As a result of intensive studies to achieve the above object, the present inventors have found that an ammonia synthesis catalyst having a specific peak pore diameter and a specific pore volume can be obtained by subjecting a catalyst support precursor including cerium oxide having a specific peak pore diameter and a specific pore volume to heat treatment in a reducing atmosphere under specific temperature conditions; the inventors have also found that this ammonia synthesis catalyst is excellent in ammonia synthesis activity, thereby completing the present invention.

That is, the present invention provides the following aspects.

[1] An ammonia synthesis catalyst comprising a catalyst support including cerium oxide and ruthenium supported on the catalyst support, wherein a peak pore diameter is in a range of 8 to 16 nm, and a pore volume in a pore diameter range of 10 to 16 nm is 0.10 cm³/g or more, and/or a pore volume in a pore diameter range of 8 to 20 nm is 0.16 cm³/g or more, as measured by a Barrett-Joyner-Halenda (BJH) method.
[2] The ammonia synthesis catalyst according to [1], wherein a pore volume in a pore diameter range of 10 to 16 nm is 0.10 cm³/g or more, and a pore volume in a pore diameter range of 8 to 20 nm is 0.16 cm³/g or more, as measured by the BJH method.
[3] The ammonia synthesis catalyst according to [1] or [2], wherein the catalyst support further contains at least one metal oxide selected from the group consisting of silicon oxide, zirconium oxide, magnesium oxide, lanthanum oxide, and aluminum oxide.
[4] The ammonia synthesis catalyst according to any one of [1] to [3], wherein an alkali metal is further supported on the catalyst support.
[5] A method for producing an ammonia synthesis catalyst, comprising the steps of: obtaining a catalyst support by subjecting a catalyst support precursor including cerium oxide to heat treatment in a reducing atmosphere at 600 to 700° C. for 5 hours or more, wherein the catalyst support precursor has a peak pore diameter in a range of 4 to 16 nm and a pore volume in a pore diameter range of 4 to 16 nm of 0.16 cm³/g or more, as measured by a Barrett-Joyner-Halenda (BJH) method after calcination in air at 500° C. for 5 hours or more; and supporting ruthenium on the catalyst support.
[6] The method for producing an ammonia synthesis catalyst according to [5], wherein the catalyst support precursor has a pore volume in a pore diameter range of 10 to 16 nm of less than 0.10 cm³/g and a pore volume in a pore diameter range of 8 to 20 nm of less than 0.16 cm³/g, as measured by the BJH method after calcination in air at 500° C. for 5 hours or more.
[7] The method for producing an ammonia synthesis catalyst according to [5] or [6], wherein the heating temperature of the catalyst support precursor is 625 to 650° C.
[8] The method for producing an ammonia synthesis catalyst according to any one of [5] to [7], further comprising a step of preparing the catalyst support precursor by impregnating cerium oxide with a solution containing at least one metal compound selected from the group consisting of a silicon compound, a zirconium compound, a magnesium compound, a lanthanum compound, and an aluminum compound.
[9] The method for producing an ammonia synthesis catalyst according to any one of [5] to [8], further comprising supporting an alkali metal on the catalyst support.
[10] A method for synthesizing ammonia, comprising contacting a gas containing hydrogen and nitrogen with the ammonia synthesis catalyst according to any one of [1] to [4] to synthesize ammonia.

The reason why the ammonia synthesis catalyst of the present invention is excellent in ammonia synthesis activity is not necessarily clear, but the present inventors speculate as follows.

First, the reason why the peak pore diameter of the pore structure in cerium oxide supports used as conventional catalyst supports is less than 8 nm or more than 16 nm will be explained. The cerium oxide support used as a conventional catalyst support has a primary particle diameter in the range of 5 to 50 nm, with many having an average primary particle diameter of about 10 nm, and the aggregation state of the primary particles in such a cerium oxide support can be roughly classified into three patterns as shown in FIGS. 1 to 3.

The cerium oxide support having the aggregation state shown in FIG. 1 has suppressed aggregation of primary particles as much as possible by devising the manufacturing process, but forms secondary particles having an average particle diameter of several tens of nm, and these secondary particles are considered to further aggregate to form tertiary particles of several μm to several tens of μm. Such an aggregated cerium oxide support shows a particle size distribution in the range of several μm to several tens of μm, which is the particle diameter of the tertiary particles, in a general particle size measurement by a laser diffraction/scattering method. In addition, the pores of the cerium oxide support in such an aggregation state are mainly gaps between secondary particles. Secondary particles having an average particle diameter of several tens of nm have a strong tendency to aggregate with each other by a certain van der Waals force, and the gaps (pores) between the secondary particles are almost constant, and in such a pore structure, the peak pore diameter is 4 nm or more and less than 8 nm, and the pore volume in the pore diameter range of 4 to 16 nm tends to be 0.16 cm³/g or more, but the pore volume in the pore diameter range of 10 to 16 nm tends to be less than 0.10 cm³/g, and the pore volume in the pore diameter range of 8 to 20 nm tends to be less than 0.16 cm³/g.

The cerium oxide support having the aggregation state shown in FIG. 2 is considered to be formed by densely aggregating many primary particles to form secondary particles of several μm to several tens of μm. Such an aggregated cerium oxide support shows a particle size distribution in the range of several μm to several tens of μm, which is the particle diameter of the secondary particles, in a general particle size measurement by a laser diffraction/scattering method. In addition, the pores of the cerium oxide support in such an aggregation state are only gaps between primary particles. In a pore structure consisting only of gaps between primary particles having an average primary particle diameter of about 10 nm, the peak pore diameter is 4 nm or less, and the pore volume in the pore diameter range of 4 to 16 nm tends to be less than 0.16 cm³/g, the pore volume in the pore diameter range of 10 to 16 nm tends to be less than 0.10 cm³/g, and the pore volume in the pore diameter range of 8 to 20 nm tends to be less than 0.16 cm³/g. Further, in such a pore structure, since there are many contact surfaces between the primary particles, a solid-phase reaction easily occurs between the primary particles, and the specific surface area and the total pore volume tend to decrease.

Furthermore, the cerium oxide support having the aggregation state shown in FIG. 3 is considered to be formed by aggregating primary particles to form secondary particles of several hundreds of nm to several μm, and these secondary particles further aggregate to form tertiary particles of several μm to several tens of μm. Such an aggregated cerium oxide support shows a particle size distribution in the range of several hundreds of nm to several μm, which is the particle diameter of the secondary particles, in a general particle size measurement by a laser diffraction/scattering method, but the width of this particle size distribution is often wide. In addition, the pores of the cerium oxide support in such an aggregation state are mainly gaps between secondary particles. In a pore structure mainly composed of gaps between secondary particles having an average particle diameter of several hundreds of nm, the peak pore diameter is several tens of nm, and the pore volume in the pore diameter range of 4 to 16 nm tends to be less than 0.16 cm³/g, the pore volume in the pore diameter range of 10 to 16 nm tends to be less than 0.10 cm³/g, and the pore volume in the pore diameter range of 8 to 20 nm tends to be less than 0.16 cm³/g.

As described above, the cerium oxide support used as a conventional catalyst support is roughly classified into three patterns depending on the aggregation state of the primary particles, and in any case, the peak pore diameter in the pore structure is less than 8 nm or more than 16 nm.

Next, the reason why an ammonia synthesis catalyst having a peak pore diameter and a predetermined pore volume within predetermined ranges is obtained by subjecting a catalyst support precursor including a cerium oxide support having the aggregation state shown in FIG. 1 to heat treatment in a reducing atmosphere under predetermined temperature conditions will be described. In the catalyst support precursor including the cerium oxide support having the aggregation state shown in FIG. 1, the primary particles are strongly bonded at the contact points between the secondary particles, and the secondary particles form the framework of the aggregated structure. When such a catalyst support precursor having an aggregated structure is subjected to heat treatment in a reducing atmosphere under predetermined temperature conditions, the primary particles grow while maintaining the contact points between the secondary particles and the framework of the aggregated structure; therefore, as shown in FIG. 4, the secondary particles shrink and the gaps (pores) between the secondary particles increase. As a result, it is considered that the pore distribution curve shifts to the larger pore diameter side, and the peak pore diameter and the predetermined pore volume increase, so that an ammonia synthesis catalyst having a peak pore diameter and a predetermined pore volume within predetermined ranges is obtained.

On the other hand, if the catalyst support precursor including the cerium oxide support having the aggregation state shown in FIG. 1 is subjected to heat treatment at a temperature lower than the predetermined temperature condition, the grain growth of the primary particles does not sufficiently proceed, so that the secondary particles hardly shrink, and the gaps (pores) between the secondary particles do not become sufficiently large. As a result, it is considered that the shift of the pore distribution curve to the larger pore diameter side is smaller than the shift when heat treatment is performed under the predetermined temperature conditions, and the peak pore diameter is smaller than the predetermined range, or the predetermined pore volume is smaller than the predetermined range.

Further, if the catalyst support precursor including the cerium oxide support having the aggregation state shown in FIG. 1 is subjected to heat treatment at a temperature higher than the predetermined temperature condition, the grain growth of the primary particles proceeds excessively, so that the secondary particles shrink excessively, and the gaps (pores) between the secondary particles become too large. As a result, it is considered that the pore distribution curve shifts greatly to the larger pore diameter side as compared with the case where the heat treatment is performed under the predetermined temperature conditions, the peak pore diameter becomes larger than the predetermined range, and the predetermined pore volume becomes smaller than the predetermined range.

On the other hand, in the catalyst support precursor including the cerium oxide support having the aggregation state shown in FIG. 2, in addition to the fact that there is originally no pore structure due to secondary particles, even if heat treatment is performed, only the pores between primary particles decrease. For this reason, it is considered that the peak pore diameter and the predetermined pore volume do not change and become smaller than the predetermined range.

Further, in the catalyst support precursor including the cerium oxide support having the aggregation state shown in FIG. 3, the peak pore diameter is larger than the predetermined range, and most of the pores have a pore diameter larger than the predetermined range; therefore, even if heat treatment is performed, an ammonia synthesis catalyst having a peak pore diameter and a predetermined pore volume within predetermined ranges cannot be obtained.

The reason why the ammonia synthesis catalyst of the present invention having a peak pore diameter and a predetermined pore volume within predetermined ranges exhibits excellent ammonia synthesis activity is speculated by the present inventors as follows. It is known that the mesopore structure of the catalyst support promotes the diffusion and transfer of reaction substrates in the gas phase (hydrogen molecules and nitrogen molecules in the present invention) to the active sites of the catalyst (ruthenium in the present invention) by aggregating the reaction substrates, thereby promoting the catalytic activity (ammonia synthesis activity in the present invention). Such an ability to aggregate the reaction substrates tends to decrease with increasing mesopore diameter if the mesopore diameter exceeds 16 nm, and becomes very low if the pore diameter exceeds 20 nm. This is considered to be because, as the pore diameter of the mesopores increases, the action on the reaction substrate approaches that of a flat surface without a pore structure. Further, if the mesopore diameter is less than 10 nm, the rate at which the reaction substrate diffuses in the mesopores tends to decrease with decreasing pore diameter, and becomes very low if the pore diameter is less than 8 nm. This is considered to be because, as the mesopore diameter decreases, the degree to which nitrogen molecules and ammonia molecules having large molecular diameters collide with the inner wall of the mesopores increases, the diffusion resistance in the mesopores increases, and diffusion onto the active sites is inhibited. Therefore, in the ammonia synthesis catalyst, the presence of mesopores excellent in the ability to aggregate the reaction substrates and the diffusibility of the reaction substrates as described above (that is, mesopores having a pore diameter in the range of 8 to 20 nm or 10 to 16 nm) becomes important.

In the conventional cerium oxide supports having the aggregation states shown in FIGS. 1 and 2, there are few mesopores that are excellent in the ability to aggregate the reaction substrates and the diffusibility of the reaction substrates as described above (that is, mesopores having a pore diameter in the range of 8 to 20 nm or 10 to 16 nm), and there are many mesopores having a pore diameter of less than 8 nm; therefore, it is presumed that the diffusion resistance in the mesopores increases, followed by inhibition of the reaction on the active sites and subsequent lowering of the ammonia synthesis activity.

In the conventional cerium oxide support having the aggregation state shown in FIG. 3, there are few mesopores that are excellent in the ability to aggregate the reaction substrates and the diffusibility of the reaction substrates as described above (that is, mesopores having a pore diameter in the range of 8 to 20 nm or 10 to 16 nm), and there are many mesopores having a pore diameter exceeding 20 nm; therefore, it is presumed that the ability to aggregate the reaction substrates is reduced, followed by lowering of the ammonia synthesis activity.

On the other hand, in the ammonia synthesis catalyst of the present invention, since a predetermined amount of mesopores having a pore diameter in the range of 8 to 20 nm or 10 to 16 nm is formed, the catalyst is excellent in the ability to aggregate the reaction substrates and the diffusibility of the reaction substrates as described above, and it is presumed that excellent ammonia synthesis activity is exhibited.

Furthermore, according to the method for producing an ammonia synthesis catalyst of the present invention, for example, the catalyst support precursor including cerium oxide having the aggregation state shown in FIG. 1 is subjected to heat treatment in a reducing atmosphere under predetermined temperature conditions to convert mesopores having a low diffusion rate of the reaction substrate (that is, mesopores having a pore diameter of less than 8 nm) into mesopores excellent in the ability to aggregate the reaction substrates and the diffusibility of the reaction substrates as described above (that is, mesopores having a pore diameter in the range of 8 to 20 nm or 10 to 16 nm); therefore, it is considered that it becomes possible to obtain an ammonia synthesis catalyst exhibiting excellent ammonia synthesis activity.

Next, the reason why the predetermined pore volume of the obtained ammonia synthesis catalyst is increased and the ammonia synthesis activity is improved by subjecting a catalyst support precursor obtained by compositing a specific metal oxide with a cerium oxide support having the aggregation state shown in FIG. 1 to heat treatment in a reducing atmosphere under predetermined temperature conditions will be described. If the catalyst support precursor including the cerium oxide support having the aggregation state shown in FIG. 1 is subjected to heat treatment in a reducing atmosphere under predetermined temperature conditions, most of the primary particles grow appropriately, so that most of the secondary particles shrink appropriately and the gaps (pores) between the secondary particles increase; however, some primary particles grow excessively, or some secondary particles shrink excessively, so that some of the gaps between the secondary particles (mesopores) disappear. On the other hand, when the catalyst support precursor obtained by compositing a specific metal oxide with the cerium oxide support having the aggregation state shown in FIG. 1 is subjected to heat treatment in a reducing atmosphere under predetermined temperature conditions, excessive grain growth of primary particles and excessive shrinkage of secondary particles are suppressed by the specific metal oxide present around the primary particles or secondary particles of cerium oxide, and disappearance of some of the gaps (mesopores) between the secondary particles is suppressed. As a result, the catalyst support including cerium oxide composited with a specific metal oxide has more mesopores with a predetermined pore diameter than the catalyst support including cerium oxide not composited with a specific metal oxide; therefore, the predetermined pore volume is increased, and the ammonia synthesis activity is improved.

### Advantageous Effects of Invention

According to the present invention, it becomes possible to obtain an ammonia synthesis catalyst excellent in ammonia synthesis activity. Further, by using this ammonia synthesis catalyst, it becomes possible to efficiently synthesize ammonia from hydrogen and nitrogen.

### BRIEF DESCRIPTION OF DRAWINGS

FIG. 1 is a conceptual diagram showing an example of the aggregation state of primary particles in a conventional cerium oxide support.

FIG. 2 is a conceptual diagram showing another example of the aggregation state of primary particles in a conventional cerium oxide support.

FIG. 3 is a conceptual diagram showing still another example of the aggregation state of primary particles in a conventional cerium oxide support.

FIG. 4 is a conceptual diagram showing the aggregation state of primary particles in a catalyst support including cerium oxide of the ammonia synthesis catalyst of the present invention.

FIG. 5 is a graph showing pore distribution curves of ammonia synthesis catalysts obtained in Examples 1 to 4 and Comparative Example 1, and cerium oxide powder A (CeO₂-A) used in these Examples and Comparative Example.

FIG. 6 is a graph showing pore distribution curves of ammonia synthesis catalysts obtained in Example 5 and Comparative Examples 2 to 3, and cerium oxide powder B (CeO₂-B) used in these Examples and Comparative Examples.

FIG. 7 is a graph showing pore distribution curves of ammonia synthesis catalysts obtained in Comparative Examples 4 to 5, and cerium oxide powder C (CeO₂-C) used in these Comparative Examples.

FIG. 8 is a graph showing pore distribution curves of the ammonia synthesis catalyst obtained in Comparative Example 6 and cerium oxide powder D (CeO₂-D) used in this Comparative Example.

FIG. 9 is a graph showing pore distribution curves of ammonia synthesis catalysts obtained in Comparative Examples 7 to 8, and cerium oxide powder E (CeO₂-E) used in these Comparative Examples.

FIG. 10 is a graph showing pore distribution curves of the ammonia synthesis catalyst obtained in Comparative Example 9 and cerium oxide powder F (CeO₂-F) used in this Comparative Example.

FIG. 11 is a graph showing ammonia synthesis activity of ammonia synthesis catalysts obtained in Examples 1 to 5 and Comparative Examples 1 to 12.

FIG. 12 is a graph showing ammonia synthesis activity of ammonia synthesis catalysts obtained in Example 2 and Examples 6 to 11.

FIG. 13 is a graph showing pore distribution curves of ammonia synthesis catalysts obtained in Example 2 and Examples 6 to 9.

FIG. 14 is a graph showing the relationship between the pore volume in the pore diameter range of 10 to 16 nm and the ammonia synthesis activity.

FIG. 15 is a graph showing the relationship between the pore volume in the pore diameter range of 8 to 20 nm and the ammonia synthesis activity.

### DESCRIPTION OF EMBODIMENTS

Hereinafter, the present invention will be described in detail based on preferred embodiments thereof.

### Ammonia Synthesis Catalyst

First, the ammonia synthesis catalyst of the present invention will be described. The ammonia synthesis catalyst of the present invention comprises a catalyst support including cerium oxide and ruthenium supported on the catalyst support, wherein a peak pore diameter is in a range of 8 to 16 nm, and a pore volume in a pore diameter range of 10 to 16 nm is 0.10 cm³/g or more, and/or a pore volume in a pore diameter range of 8 to 20 nm is 0.16 cm³/g or more, as measured by a Barrett-Joyner-Halenda (BJH) method.

The catalyst support used in the present invention includes cerium oxide, and the content thereof is preferably 60 to 100 mol %, more preferably 70 to 100 mol %, and particularly preferably 80 to 100 mol %, in terms of Ce element, relative to the total amount of all metal elements in the catalyst support.

In addition, in the catalyst support used in the present invention, from the viewpoint that at least one (preferably both) of the pore volume in a pore diameter range of 10 to 16 nm and the pore volume in a pore diameter range of 8 to 20 nm is increased, and the ammonia synthesis activity is improved in the obtained ammonia synthesis catalyst, the catalyst support preferably further includes at least one metal oxide selected from the group consisting of silicon oxide, zirconium oxide, magnesium oxide, lanthanum oxide, and aluminum oxide, more preferably further includes at least one metal oxide selected from the group consisting of silicon oxide, zirconium oxide, magnesium oxide, and aluminum oxide, and particularly preferably further includes at least one metal oxide selected from the group consisting of silicon oxide, zirconium oxide, and magnesium oxide, in addition to cerium oxide.

The content of the metal oxide is preferably 1 to 40 mol %, more preferably 2 to 30 mol %, and particularly preferably 3 to 20 mol %, in terms of the metal element, relative to the total amount of all metal elements in the catalyst support. In this case, the content of cerium oxide is preferably 60 to 99 mol %, more preferably 70 to 98 mol %, and particularly preferably 80 to 97 mol %, in terms of Ce element, relative to the total amount of all metal elements in the catalyst support. If the content of the metal oxide is less than the lower limit, the effect of compositing the metal oxide tends to be difficult to obtain sufficiently; on the other hand, if the content of the metal oxide exceeds the upper limit, the electron donating effect from cerium to ruthenium decreases, and the ammonia synthesis activity tends to decrease.

Furthermore, in the catalyst support, when the total content of cerium oxide and the metal oxide is less than 100 mol % in terms of the total amount of Ce element and the metal element, that is, when it contains a metal oxide other than cerium oxide and the metal oxide, the other metal element constituting the other metal oxide is not particularly limited, and examples thereof include rare earth elements other than cerium (Ce) and lanthanum (La) (for example, Sc, Y, Pr, Nd, Sm, Eu, Gd, Tb, Dy, Er, Yb), Group 4 elements of the periodic table other than zirconium (Zr) (for example, Ti, Hf), Group 14 elements of the periodic table other than silicon (Si) (for example, Ge, Sn), and the like.

The content of the other metal oxide is preferably 0.1 to 40 mol %, more preferably 0.5 to 30 mol %, and particularly preferably 1 to 20 mol %, in terms of the other metal element, relative to the total amount of all metal elements in the catalyst support. In this case, the content of cerium oxide is preferably 60 to 99.9 mol %, more preferably 70 to 99.5 mol %, and particularly preferably 80 to 99 mol %, in terms of Ce element, relative to the total amount of all metal elements in the catalyst support.

In addition, the catalyst support may contain a known metal element used in ammonia synthesis catalysts such as Fe, Co, Ni, and Cu, as long as the effects of the present invention are not impaired. The content of such a metal element is preferably 5 mol % or less, more preferably 1 mol % or less, and particularly preferably 0.1 mol % or less, relative to the total amount of all metal elements in the catalyst support.

The shape of such a catalyst support is not particularly limited, and examples thereof include a ring shape, a spherical shape, a cylindrical shape, a particulate shape, and a pellet shape; however, a particulate shape is preferable from the viewpoint that ruthenium (Ru) can be supported with higher dispersion.

The ammonia synthesis catalyst of the present invention is obtained by supporting ruthenium (Ru) on such a catalyst support including cerium oxide. The amount of Ru supported is not particularly limited, but is preferably 0.5 to 20 parts by mass and more preferably 1 to 10 parts by mass, relative to 100 parts by mass of the catalyst support. When the amount of Ru supported is within the above range, high ammonia synthesis activity is exhibited. On the one hand, if the amount of Ru supported is less than the lower limit, the ammonia synthesis activity tends to decrease; on the other hand, if the amount of Ru supported exceeds the upper limit, depending on the use environment of the catalyst, sintering of Ru tends to occur, so that the degree of dispersion of Ru which is an active site decreases, it becomes difficult to obtain an effect corresponding to the amount of Ru supported, and it may be disadvantageous in terms of cost and the like.

In the ammonia synthesis catalyst of the present invention, it is preferable that an alkali metal is further supported on the catalyst support. By using ruthenium and an alkali metal in combination, the electron donating effect to ruthenium is increased, so that the ammonia synthesis activity is improved. Examples of the alkali metal to be used in combination include potassium (K), rubidium (Rb), and cesium (Cs). The amount of the alkali metal supported is not particularly limited, but is preferably 0.02 to 40 parts by mass and more preferably 0.04 to 20 parts by mass, relative to 100 parts by mass of the catalyst support; in addition, it is preferably 0.05 to 10 and more preferably 0.1 to 5.0 in terms of atomic ratio (alkali metal/ruthenium) relative to the amount of ruthenium supported. If the amount of the alkali metal supported is less than the lower limit, the effect of supporting the alkali metal tends to be difficult to obtain sufficiently; on the other hand, if the amount of the alkali metal supported exceeds the upper limit, the alkali metal covers ruthenium which is the active site, so that the ammonia synthesis activity tends to decrease.

In the ammonia synthesis catalyst of the present invention, the peak pore diameter measured by the Barrett-Joyner-Halenda (BJH) method needs to be in the range of 8 to 16 nm. When the peak pore diameter is within the above range, high ammonia synthesis activity tends to be exhibited. On the other hand, if the peak pore diameter is less than the lower limit or exceeds the upper limit, both the pore volume in a pore diameter range of 10 to 16 nm and the pore volume in a pore diameter range of 8 to 20 nm measured by the BJH method become small, and the ammonia synthesis activity becomes low. Further, from the viewpoint that the ammonia synthesis activity is further enhanced, the peak pore diameter is more preferably 9 to 13 nm, and particularly preferably 9 to 11 nm.

In the ammonia synthesis catalyst of the present invention, the pore volume in a pore diameter range of 10 to 16 nm needs to be 0.10 cm³/g or more, and/or the pore volume in a pore diameter range of 8 to 20 nm needs to be 0.16 cm³/g or more, as measured by the BJH method. When at least one of the pore volume in the pore diameter range of 10 to 16 nm and the pore volume in the pore diameter range of 8 to 20 nm is within the above range, high ammonia synthesis activity is exhibited. On the other hand, if both the pore volume in the pore diameter range of 10 to 16 nm and the pore volume in the pore diameter range of 8 to 20 nm are less than the lower limit, the ammonia synthesis activity becomes low. Further, from the viewpoint that the ammonia synthesis activity is further enhanced, it is preferable that both the pore volume in the pore diameter range of 10 to 16 nm and the pore volume in the pore diameter range of 8 to 20 nm are within the above range.

Furthermore, in the ammonia synthesis catalyst of the present invention, from the viewpoint that the ammonia synthesis activity is further enhanced, the pore volume in the pore diameter range of 10 to 16 nm is preferably 0.11 cm³/g or more, and the pore volume in the pore diameter range of 8 to 20 nm is preferably 0.17 cm³/g or more, and more preferably 0.18 cm³/g or more.

In the ammonia synthesis catalyst of the present invention, the total pore volume measured by the BJH method is not particularly limited, but is preferably 0.10 cm³/g or more, more preferably 0.15 cm³/g or more, and particularly preferably 0.18 cm³/g or more. If the total pore volume is less than the lower limit, both the pore volume in the pore diameter range of 10 to 16 nm and the pore volume in the pore diameter range of 8 to 20 nm tend to be smaller than a predetermined range, and the ammonia synthesis activity tends to be low.

In the present invention, the peak pore diameter, the total pore volume, the pore volume in the pore diameter range of 10 to 16 nm, and the pore volume in the pore diameter range of 8 to 20 nm of the ammonia synthesis catalyst can be determined by the following method. Specifically, a nitrogen adsorption/desorption isotherm of the ammonia synthesis catalyst is determined at an adsorption temperature of −197° C. according to a conventionally known nitrogen gas adsorption method, a pore distribution curve is determined by the BJH method based on the obtained nitrogen adsorption/desorption isotherm, and the peak pore diameter of the ammonia synthesis catalyst, the pore volume in the pore diameter range of 10 to 16 nm, and the pore volume in the pore diameter range of 8 to 20 nm can be determined based on this pore distribution curve.

In the ammonia synthesis catalyst of the present invention, the specific surface area measured by the Brunauer-Emmett-Teller (BET) method is not particularly limited, but is preferably 5 to 300 m²/g, more preferably 10 to 200 m²/g, and particularly preferably 20 to 150 m²/g. If the specific surface area is less than the lower limit, the degree of dispersion of Ru tends to decrease, and the ammonia synthesis activity tends to decrease; on the other hand, if the specific surface area exceeds the upper limit, the heat resistance of the catalyst support tends to decrease, and the ammonia synthesis activity tends to decrease.

In the present invention, the specific surface area of the ammonia synthesis catalyst can be determined by the following method. Specifically, a nitrogen adsorption isotherm of the ammonia synthesis catalyst is determined at an adsorption temperature of −197° C. according to a conventionally known nitrogen gas adsorption method, and the specific surface area of the ammonia synthesis catalyst can be determined by the BET method based on the obtained nitrogen adsorption isotherm.

The form of the ammonia synthesis catalyst of the present invention is not particularly limited, and examples thereof include a honeycomb-shaped monolithic catalyst and a pellet-shaped pellet catalyst. Further, the powdery ammonia synthesis catalyst may be directly arranged at a desired location.

### Method for Producing Ammonia Synthesis Catalyst

Next, the method for producing the ammonia synthesis catalyst of the present invention will be described. The method for producing the ammonia synthesis catalyst of the present invention includes: a step [Support Preparation Step] of obtaining a catalyst support by subjecting a catalyst support precursor including cerium oxide to heat treatment in a reducing atmosphere at 600 to 700° C. for 5 hours or more, wherein the catalyst support precursor has a peak pore diameter in a range of 4 to 16 nm and a pore volume in a pore diameter range of 4 to 16 nm of 0.16 cm³/g or more, as measured by a Barrett-Joyner-Halenda (BJH) method after calcination in air at 500° C. for 5 hours or more; a step [Ruthenium Supporting Step] of supporting ruthenium on the catalyst support; and optionally a step [Alkali Metal Supporting Step] of supporting an alkali metal.

### Support Preparation Step

The catalyst support precursor used in the present invention includes cerium oxide, and the content thereof is preferably 60 to 100 mol %, more preferably 70 to 100 mol %, and particularly preferably 80 to 100 mol %, in terms of Ce element, relative to the total amount of all metal elements in the catalyst support precursor.

In addition, from the viewpoint that at least one (preferably both) of the pore volume in a pore diameter range of 10 to 16 nm and the pore volume in a pore diameter range of 8 to 20 nm is increased in the obtained catalyst support, and the ammonia synthesis activity is improved in the obtained ammonia synthesis catalyst, the catalyst support precursor preferably further includes at least one metal oxide selected from the group consisting of silicon oxide, zirconium oxide, magnesium oxide, lanthanum oxide, and aluminum oxide, more preferably further includes at least one metal oxide selected from the group consisting of silicon oxide, zirconium oxide, magnesium oxide, and aluminum oxide, and particularly preferably further includes at least one metal oxide selected from the group consisting of silicon oxide, zirconium oxide, and magnesium oxide, in addition to cerium oxide.

The method for preparing the catalyst support precursor containing cerium oxide and the metal oxide is not particularly limited, and examples thereof include a method of impregnating cerium oxide with a solution containing at least one metal compound selected from the group consisting of a silicon compound, a zirconium compound, a magnesium compound, a lanthanum compound, and an aluminum compound, and optionally drying (evaporating to dryness). Examples of the metal compound include silane compounds, inorganic salts of the metal (for example, nitrates, acetates, chlorides, sulfates, and the like), complexes of the metal, and organic acid salts. Moreover, the solvent used in the solution containing the metal compound is not particularly limited as long as it dissolves the metal compound, and examples thereof include water, alcohol, and tetrahydrofuran (THF). Note that the concentration of the metal compound in the solution containing the metal compound can be appropriately set according to the content of the metal oxide.

When preparing the catalyst support precursor containing cerium oxide and the metal oxide, it is desirable to impregnate cerium oxide with a solution containing the metal compound so that the content of the metal oxide is preferably 1 to 40 mol %, more preferably 2 to 30 mol %, and particularly preferably 3 to 20 mol %, in terms of the metal element, relative to the total amount of all metal elements in the catalyst support precursor. If cerium oxide is impregnated with a solution containing the metal compound in such an amount that the content of the metal oxide is less than the lower limit, the effect of compositing the metal oxide tends to be difficult to obtain sufficiently; on the other hand, if cerium oxide is impregnated with a solution containing the metal compound in such an amount that the content of the metal oxide exceeds the upper limit, the electron donating effect from cerium to ruthenium decreases, and the ammonia synthesis activity tends to decrease.

Furthermore, in the catalyst support precursor, when the total content of cerium oxide and the metal oxide is less than 100 mol % in terms of the total amount of Ce element and the metal element, that is, when it contains a metal oxide other than cerium oxide and the metal oxide, the other metal element constituting the other metal oxide is not particularly limited, and examples thereof include rare earth elements other than cerium (Ce) and lanthanum (La) (for example, Sc, Y, Pr, Nd, Sm, Eu, Gd, Tb, Dy, Er, Yb), Group 4 elements of the periodic table other than zirconium (Zr) (for example, Ti, Hf), Group 14 elements of the periodic table other than silicon (Si) (for example, Ge, Sn), and the like.

The content of the other metal oxide is preferably 0.1 to 40 mol %, more preferably 0.5 to 30 mol %, and particularly preferably 1 to 20 mol %, in terms of the other metal element, relative to the total amount of all metal elements in the catalyst support precursor. In this case, the content of cerium oxide is preferably 60 to 99.9 mol %, more preferably 70 to 99.5 mol %, and particularly preferably 80 to 99 mol %, in terms of Ce element, relative to the total amount of all metal elements in the catalyst support precursor.

In addition, the catalyst support precursor may contain a known metal element used in ammonia synthesis catalysts such as Fe, Co, Ni, and Cu, as long as the effects of the present invention are not impaired. The content of such a metal element is preferably 5 mol % or less, more preferably 1 mol % or less, and particularly preferably 0.1 mol % or less, relative to the total amount of all metal elements in the catalyst support precursor.

In the catalyst support precursor used in the present invention, the peak pore diameter measured by the BJH method after calcination in air at 500° C. for 5 hours or more needs to be in the range of 4 to 16 nm. When the peak pore diameter is within the above range, by performing heat treatment under predetermined temperature conditions, the peak pore diameter increases, and the ammonia synthesis catalyst of the present invention having a peak pore diameter and a predetermined pore volume within predetermined ranges can be obtained. On the other hand, if the peak pore diameter is less than the lower limit or exceeds the upper limit, even if heat treatment is performed under predetermined temperature conditions, the peak pore diameter hardly changes, and the ammonia synthesis catalyst of the present invention having a peak pore diameter and a predetermined pore volume within predetermined ranges cannot be obtained. Further, from the viewpoint that an ammonia synthesis catalyst having higher ammonia synthesis activity can be obtained, the peak pore diameter of the catalyst support precursor is more preferably 4.5 to 13 nm, still more preferably 5 to 11 nm, and particularly preferably 5.5 to 10 nm.

In the catalyst support precursor used in the present invention, the pore volume in the pore diameter range of 4 to 16 nm measured by the BJH method after calcination in air at 500° C. for 5 hours or more needs to be 0.16 cm³/g or more. When the pore volume is within the above range, by performing heat treatment under predetermined temperature conditions, at least one (preferably both) of the pore volume in a pore diameter range of 10 to 16 nm and the pore volume in a pore diameter range of 8 to 20 nm measured by the BJH method is increased, and the ammonia synthesis catalyst of the present invention in which at least one (preferably both) of these pore volumes is within a predetermined range can be obtained. On the other hand, if the pore volume is less than the lower limit, even if heat treatment is performed under predetermined temperature conditions, both the pore volume in the pore diameter range of 10 to 16 nm and the pore volume in the pore diameter range of 8 to 20 nm do not sufficiently increase, and the ammonia synthesis catalyst of the present invention in which at least one of these pore volumes is within a predetermined range cannot be obtained.

In the catalyst support precursor used in the present invention, it is preferable that the pore volume in a pore diameter range of 10 to 16 nm is less than 0.10 cm³/g, and the pore volume in a pore diameter range of 8 to 20 nm is less than 0.16 cm³/g, as measured by the BJH method after calcination in air at 500° C. for 5 hours or more. By subjecting a catalyst support precursor having such a pore volume to heat treatment under predetermined temperature conditions, the effect of the method for producing the ammonia synthesis catalyst of the present invention is maximized; therefore, at least one (preferably both) of the pore volumes is increased, and the ammonia synthesis catalyst of the present invention in which at least one (preferably both) of these pore volumes is within a predetermined range can be obtained.

In the support preparation step, the catalyst support is obtained by subjecting a catalyst support precursor having such pore characteristics to heat treatment in a reducing atmosphere at 600 to 700° C. for 5 hours or more. By the heat treatment, the peak pore diameter and at least one (preferably both) of the pore volume in the pore diameter range of 10 to 16 nm and the pore volume in the pore diameter range of 8 to 20 nm are increased, and the ammonia synthesis catalyst of the present invention having a peak pore diameter and a predetermined pore volume within predetermined ranges can be obtained.

On the other hand, when the heating temperature is less than the lower limit, the peak pore diameter and the predetermined pore volume do not sufficiently increase, and the ammonia synthesis catalyst of the present invention having a peak pore diameter and a predetermined pore volume within predetermined ranges cannot be obtained. On the other hand, when the heating temperature exceeds the upper limit, the peak pore diameter becomes too large, and the predetermined pore volume does not sufficiently increase; therefore, the ammonia synthesis catalyst of the present invention having a peak pore diameter and a predetermined pore volume within predetermined ranges cannot be obtained. Furthermore, from the viewpoint that the ammonia synthesis catalyst of the present invention in which both the pore volume in the pore diameter range of 10 to 16 nm and the pore volume in the pore diameter range of 8 to 20 nm are within predetermined ranges can be obtained, the heating temperature is preferably 625 to 650° C.

Further, when the heating time is less than the lower limit, the peak pore diameter and the predetermined pore volume do not sufficiently increase, and the ammonia synthesis catalyst of the present invention having a peak pore diameter and a predetermined pore volume within predetermined ranges cannot be obtained. Furthermore, since the activity changes as the catalyst is used, the control during ammonia synthesis becomes complicated.

### Ruthenium Supporting Step

Next, an ammonia synthesis catalyst is obtained by supporting ruthenium (Ru) on the catalyst support thus obtained. Specifically, first, an Ru precursor is attached to the catalyst support using a solution containing a salt of Ru.

The salt of Ru is not particularly limited, and examples thereof include acetates, nitrates, ammonium salts, citrates, dinitrodiammine salts, chlorides, and various complexes (for example, tetraammine complex and carbonyl complex) of Ru. Of these Ru salts, dodecacarbonyltriruthenium [Ru₃(CO)₁₂], ruthenium acetylacetonate, ruthenium nitrosyl nitrate, and ruthenium nitrate are preferable. In addition, the solvent used in the solution containing the salt of Ru is not particularly limited as long as the salt of Ru is dissolved therein and Ru ions are formed, and examples thereof include tetrahydrofuran (THF), water, and alcohol. Note that the concentration of the salt of Ru in the solution containing the salt of Ru can be appropriately set according to the amount of Ru supported.

The method for attaching the Ru precursor to the catalyst support is not particularly limited, and examples thereof include a method (impregnation method) of immersing the catalyst support in a solution containing the salt of Ru to impregnate the catalyst support with the salt of Ru, and a method (adsorption method) of adsorbing the solution containing the salt of Ru to the catalyst support.

In this ruthenium supporting step, it is desirable to attach the Ru precursor to the catalyst support so that the amount of Ru supported relative to 100 parts by mass of the catalyst support is preferably 0.5 to 20 parts by mass and more preferably 1 to 10 parts by mass. If the Ru precursor is attached in such an amount that the amount of Ru supported is less than the lower limit, the ammonia synthesis activity tends to decrease in the obtained ammonia synthesis catalyst; on the other hand, if the Ru precursor is attached in such an amount that the amount of Ru supported exceeds the upper limit, depending on the use environment of the catalyst, sintering of Ru tends to occur, so that the degree of dispersion of Ru which is the active site decreases, it becomes difficult to obtain an effect corresponding to the amount of Ru supported, and it may be disadvantageous in terms of cost and the like.

Next, an ammonia synthesis catalyst in which Ru is supported on the catalyst support is obtained by drying the catalyst support to which the Ru precursor is attached in this way, and then calcining it in a reducing gas atmosphere or an inert gas atmosphere. In particular, since the catalyst support is calcined in a reducing gas atmosphere or an inert gas atmosphere (preferably in a reducing gas atmosphere), Ru is supported on the catalyst support in a metal state, and an ammonia synthesis catalyst excellent in ammonia synthesis activity can be obtained.

The drying temperature of the catalyst support is preferably 50 to 150° C., and more preferably 75 to 125° C. Moreover, the drying time is preferably 3 hours or more, and more preferably 5 hours or more.

The reducing gas atmosphere is an atmosphere containing a reducing gas such as hydrogen gas, carbon monoxide gas, or hydrocarbon gas, and examples thereof include a mixed gas atmosphere of the reducing gas and an inert gas (nitrogen gas, argon gas, and the like). The concentration of the reducing gas in such a mixed gas atmosphere is preferably 1 to 30% by volume, and more preferably 5 to 20% by volume. Moreover, examples of the inert gas atmosphere include a nitrogen gas atmosphere, an argon gas atmosphere, and a helium gas atmosphere.

The calcination temperature of the catalyst support after drying is preferably 200 to 500° C., and more preferably 300 to 500° C. Moreover, the calcination time is preferably 0.5 to 20 hours, and more preferably 1 to 10 hours. If the calcination temperature or the calcination time is less than the lower limit, it becomes difficult to fully reduce all the Ru to a metal state, and some Ru tends to remain in its precursor state; on the other hand, even if the calcination temperature or the calcination time exceeds the upper limit, the activity of the obtained ammonia synthesis catalyst hardly changes, and the gas and heating energy for calcination are wasted.

### Alkali Metal Supporting Step

In the method for producing an ammonia synthesis catalyst of the present invention, it is preferable to further support an alkali metal as needed. Specifically, first, an alkali metal precursor is attached to the ammonia synthesis catalyst obtained in the ruthenium supporting step using a solution containing an alkali metal salt.

Examples of the alkali metal include potassium (K), rubidium (Rb), and cesium (Cs). The alkali metal salt is not particularly limited, and examples thereof include nitrates, acetates, carbonates, bicarbonates, hydroxides, chlorides, and sulfates of alkali metals. Moreover, the solvent used in the solution containing the alkali metal salt is not particularly limited as long as the alkali metal salt is dissolved therein and alkali metal ions are formed, and examples thereof include water, alcohol, and tetrahydrofuran (THF). Note that the concentration of the alkali metal salt in the solution containing the alkali metal salt can be appropriately set according to the amount of the alkali metal supported.

The method for attaching the alkali metal precursor to the ammonia synthesis catalyst is not particularly limited, and examples thereof include a method (impregnation method) of immersing the ammonia synthesis catalyst in a solution containing an alkali metal salt to impregnate the ammonia synthesis catalyst with the alkali metal salt, and a method (adsorption method) of adsorbing the solution containing the alkali metal salt to the ammonia synthesis catalyst.

In this alkali metal supporting step, it is desirable to attach the alkali metal precursor to the ammonia synthesis catalyst so that the amount of the alkali metal supported is preferably 0.02 to 40 parts by mass and more preferably 0.04 to 20 parts by mass relative to 100 parts by mass of the catalyst support, and preferably 0.05 to 10 and more preferably 0.1 to 5 in terms of atomic ratio (alkali metal/ruthenium) relative to the amount of ruthenium supported. If the alkali metal precursor is attached in such an amount that the amount of the alkali metal supported is less than the lower limit, the effect of supporting the alkali metal tends to be difficult to obtain sufficiently in the obtained ammonia synthesis catalyst; on the other hand, if the alkali metal precursor is attached in such an amount that the amount of the alkali metal supported exceeds the upper limit, the alkali metal covers ruthenium which is the active site, so that the ammonia synthesis activity tends to decrease.

Next, an ammonia synthesis catalyst in which ruthenium and an alkali metal are supported on the catalyst support is obtained by drying the ammonia synthesis catalyst to which the alkali metal precursor is attached in this way. The drying temperature of the ammonia synthesis catalyst is preferably 50 to 150° C., and more preferably 75 to 125° C. Moreover, the drying time is preferably 0.5 hours or more, and more preferably 1 hour or more.

In the method for producing an ammonia synthesis catalyst of the present invention, the ammonia synthesis catalyst thus produced may be processed into various forms by a known method. For example, the catalyst may be processed into a pellet shape, or may be coated on various base materials such as a monolith-shaped base material, a pellet-shaped base material, and a plate-shaped base material.

### Method for Synthesizing Ammonia

Next, the method for synthesizing ammonia of the present invention will be described. The method for synthesizing ammonia of the present invention is a method of contacting a mixed gas containing hydrogen and nitrogen with the ammonia synthesis catalyst of the present invention to synthesize ammonia. The method of contacting the mixed gas containing hydrogen and nitrogen with the ammonia synthesis catalyst is not particularly limited, and the method in a known method for synthesizing ammonia can be adopted as is.

In the method for synthesizing ammonia of the present invention, the synthesis conditions are not particularly limited, and the conditions in a known method for synthesizing ammonia can be adopted as is; for example, the molar ratio of hydrogen to nitrogen (H₂/N₂) is preferably 0.1/1 to 5/1, and more preferably 0.5/1 to 3/1. In addition, the mixed gas containing hydrogen and nitrogen may contain an inert gas (argon gas or the like) as a carrier gas, but a gas consisting only of hydrogen and nitrogen is preferable from the viewpoint of ammonia production efficiency.

The reaction temperature is preferably 300 to 500° C., and more preferably 300 to 450° C. Moreover, the reaction pressure is preferably 0.1 to 10 MPa, and more preferably 0.1 to 8 MPa.

### EXAMPLES

Hereinafter, the present invention will be described more specifically based on Examples and Comparative Examples; however, the present invention is not limited to the following Examples. Note that the specific surface area, peak pore diameter, and pore volume were determined by the following methods.

### Specific Surface Area, Peak Pore Diameter, and Pore Volume

A nitrogen adsorption/desorption isotherm was determined by a nitrogen gas adsorption method at an adsorption temperature of −197° C. using a specific surface area/pore distribution measuring device (“BELSORP-mini II” manufactured by MicrotracBEL Corp.). A specific surface area was determined by the Brunauer-Emmett-Teller (BET) method based on the obtained nitrogen adsorption isotherm. Furthermore, a pore distribution curve was determined by the Barrett-Joyner-Halenda (BJH) method based on the obtained nitrogen adsorption/desorption isotherm, and a peak pore diameter, a total pore volume, and pore volumes in pore diameter ranges of 10 to 16 nm, 8 to 20 nm, and 4 to 16 nm were determined based on the pore distribution curve.

### Measurement of Specific Surface Area and Pore Characteristics of Catalyst Support Precursor

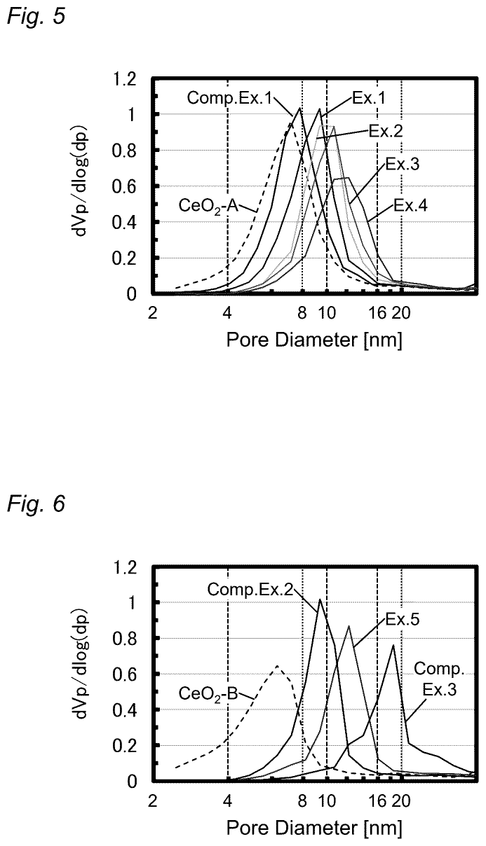

First, the specific surface area and pore characteristics of each catalyst support precursor to be used in the following Examples and Comparative Examples were measured. Specifically, commercially available cerium oxide powders A to F (hereinafter referred to as “CeO₂-A” to “CeO₂-F”, respectively. “CeO₂-A” and “CeO₂-C” to “CeO₂-F” are manufactured by Anan Kasei Co., Ltd., and “CeO₂-B” is manufactured by Daiichi Kigenso Kagaku Kogyo Co., Ltd.) were calcined in air at 500° C. for 5 hours, and then the specific surface area, the pore distribution curve, the peak pore diameter, the total pore volume, and the pore volumes in pore diameter ranges of 10 to 16 nm, 8 to 20 nm, and 4 to 16 nm were determined according to the above method. These results are shown in FIGS. 5 to 10 and Table 1.

TABLE 1

| | Specific | Total | Peak | Pore Volume [cm³/g] | | |
|---|---|---|---|---|---|---|
| Cerium Oxide | Surface Area | Pore Volume | Pore Diameter | Pore Diameter | Pore Diameter | Pore Diameter |
| Powder | [m²/g] | [cm³/g] | [nm] | of 4 to 16 nm | of 10 to 16 nm | of 8 to 20 nm |
| CeO₂-A | 134.8 | 0.289 | 7.2 | 0.243 | 0.030 | 0.093 |
| CeO₂-B | 130.1 | 0.252 | 6.3 | 0.169 | 0.011 | 0.035 |
| CeO₂-C | 144.4 | 0.103 | 3.3 | 0.016 | 0.005 | 0.010 |
| CeO₂-D | 66.8 | 0.090 | 3.5 | 0.031 | 0.004 | 0.009 |
| CeO₂-E | 112.0 | 0.207 | 50.4 | 0.023 | 0.009 | 0.018 |
| CeO₂-F | 35.4 | 0.181 | 37.4 | 0.034 | 0.017 | 0.033 |

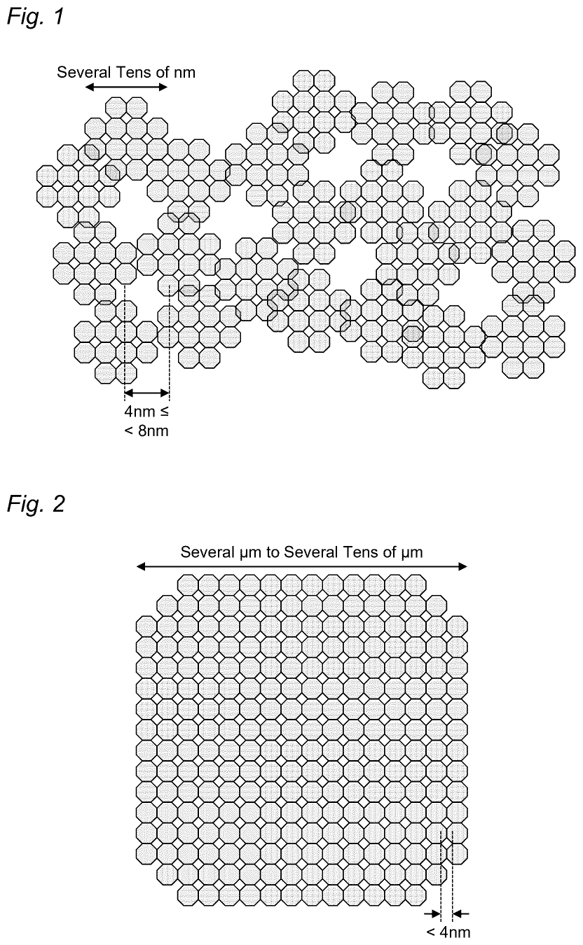

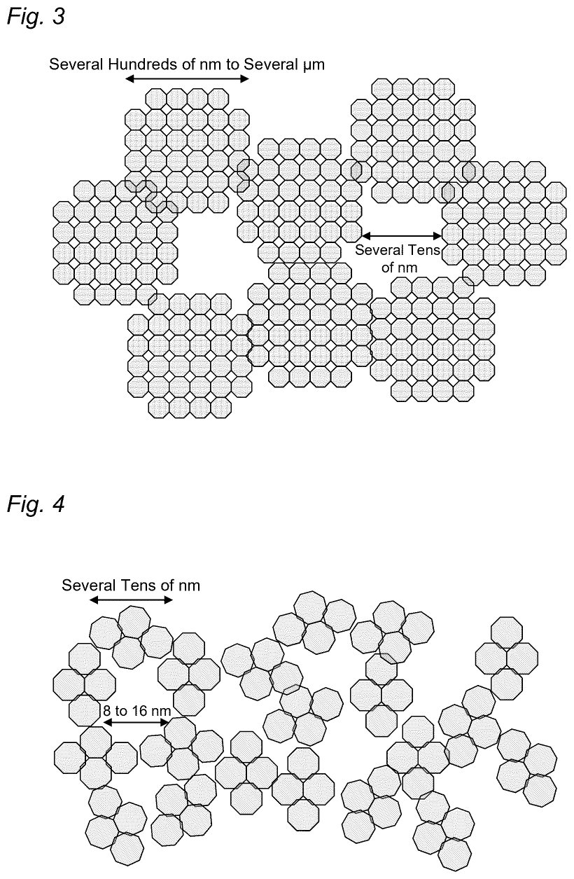

From the results shown in Table 1, it is considered that CeO₂-A and CeO₂-B have the pore structure shown in FIG. 1, CeO₂-C and CeO₂-D have the pore structure shown in FIG. 2, and CeO₂-E and CeO₂-F have the pore structure shown in FIG. 3.

### Example 1

A catalyst support powder was prepared by subjecting commercially available cerium oxide powder A (CeO₂-A) having the specific surface area and pore characteristics shown in Table 1 to heat treatment in a hydrogen (10%)/nitrogen (balance) gas stream at 600° C. for 5 hours. This catalyst support powder was impregnated with an aqueous solution obtained by diluting a nitric acid solution of ruthenium(III) nitrosyl nitrate (Ru(NO)(NO₃)₃ HNO₃ soln, manufactured by Furuya Metal Co., Ltd.) with water, and then evaporated to dryness at 70° C. The obtained dried product was heated in a hydrogen (10%)/nitrogen (balance) gas stream at 300° C. for 2 hours, and then subjected to pressure molding and crushing treatment to obtain a pelletized ammonia synthesis catalyst (pellet diameter: 0.150 to 0.250 mm) in which 3.23 parts by mass of ruthenium was supported relative to 100 parts by mass of the catalyst support powder. The packing density (pellet density) of this catalyst was 1.43 g/ml.

### Example 2

A pelletized ammonia synthesis catalyst (pellet diameter: 0.150 to 0.250 mm) in which 3.19 parts by mass of ruthenium was supported relative to 100 parts by mass of a catalyst support powder was obtained in the same manner as in Example 1, except that the heating temperature of CeO₂-A was changed to 625° C. The packing density (pellet density) of this catalyst was 1.45 g/ml.

### Example 3

A pelletized ammonia synthesis catalyst (pellet diameter: 0.150 to 0.250 mm) in which 3.15 parts by mass of ruthenium was supported relative to 100 parts by mass of a catalyst support powder was obtained in the same manner as in Example 1, except that the heating temperature of CeO₂-A was changed to 650° C. The packing density (pellet density) of this catalyst was 1.47 g/ml.

### Example 4

A pelletized ammonia synthesis catalyst (pellet diameter: 0.150 to 0.250 mm) in which 3.11 parts by mass of ruthenium was supported relative to 100 parts by mass of a catalyst support powder was obtained in the same manner as in Example 1, except that the heating temperature of CeO₂-A was changed to 675° C. The packing density (pellet density) of this catalyst was 1.49 g/ml.

### Example 5

A pelletized ammonia synthesis catalyst (pellet diameter: 0.150 to 0.250 mm) in which 3.13 parts by mass of ruthenium was supported relative to 100 parts by mass of a catalyst support powder was obtained in the same manner as in Example 3, except that commercially available cerium oxide powder B (CeO₂-B) having the specific surface area and pore characteristics shown in Table 1 was used instead of CeO₂-A. The packing density (pellet density) of this catalyst was 1.48 g/ml.

### Comparative Example 1

A pelletized ammonia synthesis catalyst (pellet diameter: 0.150 to 0.250 mm) in which 3.26 parts by mass of ruthenium was supported relative to 100 parts by mass of a catalyst support powder was obtained in the same manner as in Example 1, except that CeO₂-A was subjected to heat treatment in air at 500° C. for 5 hours instead of the heat treatment in a hydrogen (10%)/nitrogen (balance) gas stream at 600° C. for 5 hours. The packing density (pellet density) of this catalyst was 1.42 g/ml.

### Comparative Example 2

A pelletized ammonia synthesis catalyst (pellet diameter: 0.150 to 0.250 mm) in which 3.13 parts by mass of ruthenium was supported relative to 100 parts by mass of a catalyst support powder was obtained in the same manner as in Comparative Example 1, except that CeO₂-B was used instead of CeO₂-A. The packing density (pellet density) of this catalyst was 1.48 g/ml.

### Comparative Example 3

A pelletized ammonia synthesis catalyst (pellet diameter: 0.150 to 0.250 mm) in which 3.13 parts by mass of ruthenium was supported relative to 100 parts by mass of a catalyst support powder was obtained in the same manner as in Example 5, except that the heating temperature of CeO₂-B was changed to 725° C. The packing density (pellet density) of this catalyst was 1.48 g/ml.

### Comparative Example 4

A pelletized ammonia synthesis catalyst (pellet diameter: 0.150 to 0.250 mm) in which 2.49 parts by mass of ruthenium was supported relative to 100 parts by mass of a catalyst support powder was obtained in the same manner as in Comparative Example 1, except that commercially available cerium oxide powder C (CeO₂-C) having the specific surface area and pore characteristics shown in Table 1 was used instead of CeO₂-A. The packing density (pellet density) of this catalyst was 1.86 g/ml.

### Comparative Example 5

A pelletized ammonia synthesis catalyst (pellet diameter: 0.150 to 0.250 mm) in which 2.43 parts by mass of ruthenium was supported relative to 100 parts by mass of a catalyst support powder was obtained in the same manner as in Example 3, except that CeO₂-C was used instead of CeO₂-A. The packing density (pellet density) of this catalyst was 1.91 g/ml.

### Comparative Example 6

A pelletized ammonia synthesis catalyst (pellet diameter: 0.150 to 0.250 mm) in which 2.38 parts by mass of ruthenium was supported relative to 100 parts by mass of a catalyst support powder was obtained in the same manner as in Example 3, except that commercially available cerium oxide powder D (CeO₂-D) having the specific surface area and pore characteristics shown in Table 1 was used instead of CeO₂-A. The packing density (pellet density) of this catalyst was 1.95 g/ml.

### Comparative Example 7

A pelletized ammonia synthesis catalyst (pellet diameter: 0.150 to 0.250 mm) in which 2.64 parts by mass of ruthenium was supported relative to 100 parts by mass of a catalyst support powder was obtained in the same manner as in Comparative Example 1, except that commercially available cerium oxide powder E (CeO₂-E) having the specific surface area and pore characteristics shown in Table 1 was used instead of CeO₂-A. The packing density (pellet density) of this catalyst was 1.75 g/ml.

### Comparative Example 8

A pelletized ammonia synthesis catalyst (pellet diameter: 0.150 to 0.250 mm) in which 2.50 parts by mass of ruthenium was supported relative to 100 parts by mass of a catalyst support powder was obtained in the same manner as in Example 4, except that CeO₂-E was used instead of CeO₂-A. The packing density (pellet density) of this catalyst was 1.85 g/ml.

### Comparative Example 9

A pelletized ammonia synthesis catalyst (pellet diameter: 0.150 to 0.250 mm) in which 2.41 parts by mass of ruthenium was supported relative to 100 parts by mass of a catalyst support powder was obtained in the same manner as in Example 4, except that commercially available cerium oxide powder F (CeO₂-F) having the specific surface area and pore characteristics shown in Table 1 was used instead of CeO₂-A. The packing density (pellet density) of this catalyst was 1.93 g/ml.

### Comparative Example 10

An ammonia synthesis catalyst (CeO₂-supported Ru catalyst) was prepared according to the method described in JP 2021-109130 A (PTL 1) using a potassium hydroxide aqueous solution as a precipitant. Specifically, cerium nitrate was dissolved in about 10 times the mass thereof of ion-exchanged water to prepare a cerium nitrate aqueous solution, and a 0.1 mol/L potassium hydroxide aqueous solution was gradually added to this cerium nitrate aqueous solution to adjust the pH to 10 or more. The precipitate obtained at this time was calcined in air at 500° C. for 5 hours to obtain cerium oxide powder. This cerium oxide powder was impregnated with an aqueous solution obtained by diluting a nitric acid solution of ruthenium(III) nitrosyl nitrate (Ru(NO)(NO₃)₃ HNO₃ soln, manufactured by Furuya Metal Co., Ltd.) with water, and then heated in a hydrogen (10%)/nitrogen (balance) gas stream at 300° C. for 1 hour, and subjected to pressure molding and crushing treatment to obtain a pelletized ammonia synthesis catalyst (pellet diameter: 0.150 to 0.250 mm) in which 2.58 parts by mass of ruthenium was supported relative to 100 parts by mass of the cerium oxide powder. The packing density (pellet density) of this catalyst was 1.80 g/ml.

### Comparative Example 11

An ammonia synthesis catalyst (CeO₂-supported Ru catalyst) was prepared according to the method described in JP 2021-109130 A (PTL 1) using an ammonia aqueous solution as a precipitant. Specifically, a pelletized ammonia synthesis catalyst (pellet diameter: 0.150 to 0.250 mm) in which 2.58 parts by mass of ruthenium was supported relative to 100 parts by mass of cerium oxide powder was obtained in the same manner as in Comparative Example 10, except that 27% ammonia water was used instead of the potassium hydroxide aqueous solution. The packing density (pellet density) of this catalyst was 1.80 g/ml.

### Comparative Example 12

An ammonia synthesis catalyst was prepared according to the method described in Journal of Rare Earths, 2019, Vol. 37, pp. 492-499 (NPL 1). Specifically, diammonium cerium (IV) nitrate (manufactured by FUJIFILM Wako Pure Chemical Corporation) and lanthanum nitrate hexahydrate (manufactured by FUJIFILM Wako Pure Chemical Corporation) were dissolved in a minimum amount of ion-exchanged water at room temperature so that the molar ratio of Ce to La was Ce:La=1:1. Here, the “minimum amount” of ion-exchanged water is the minimum amount of ion-exchanged water capable of completely dissolving a predetermined amount of diammonium cerium(IV) nitrate and lanthanum nitrate hexahydrate. To the obtained aqueous solution, 6 equivalents of citric acid (manufactured by FUJIFILM Wako Pure Chemical Corporation) was added relative to the total amount of cations, and the mixture was stirred at 80° C. for 5 hours to prepare a complex aqueous solution. Thereafter, this complex aqueous solution was heated at 80° C. for 12 hours to remove water, followed by calcining in air at 500° C. for 5 hours to obtain a precursor powder. Thereafter, this precursor powder was calcined in air at 700° C. for 10 hours to obtain a ceria-lanthana composite oxide powder (La₂Ce₂O₇).

Next, dodecacarbonyltriruthenium (manufactured by Sigma-Aldrich Co. LLC.) was dissolved in tetrahydrofuran (manufactured by FUJIFILM Wako Pure Chemical Corporation), and the ceria-lanthana composite oxide powder was added to the obtained solution and stirred for 5 hours. The obtained dispersion was heated at 50° C. to remove tetrahydrofuran, and then the obtained powder was dried at 80° C. for 18 hours, and further calcined at 500° C. for 3 hours under a nitrogen flow to obtain a powdery ammonia synthesis catalyst in which 3.09 parts by mass of ruthenium was supported relative to 100 parts by mass of the ceria-lanthana composite oxide powder. The packing density (pellet density) of this catalyst was 1.50 g/ml.

### Ammonia Synthesis Reaction

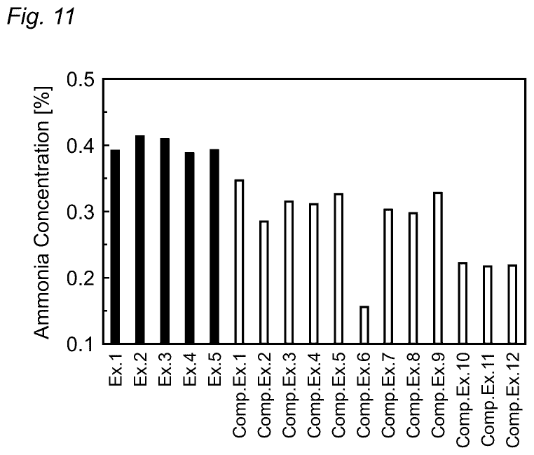

The ammonia synthesis catalysts obtained in Examples 1 to 5 and Comparative Examples 1 to 12 were respectively filled in reaction tubes so that the ruthenium content was 0.006 g relative to a catalyst bed volume of 0.133 ml, and these reaction tubes were installed in a fixed bed flow type reactor. While supplying a mixed gas of hydrogen (75%)/nitrogen (balance) to this ammonia synthesis catalyst at a flow rate of 80 ml/min and a pressure of 0.1 MPa, the ammonia synthesis catalyst was heated at 600° C. for 30 minutes for pretreatment, then cooled to 350° C., and subsequently an ammonia synthesis reaction was performed at 350° C. One hour after the start of the synthesis reaction, the ammonia concentration of the catalyst outlet gas was measured using a Fourier transform infrared (FT-IR) spectrometer installed at the outlet of the reactor. The results are shown in Table 2 and FIG. 11.

### Measurement of Specific Surface Area and Pore Characteristics of Ammonia Synthesis Catalyst

The specific surface area, the pore distribution curve, the peak pore diameter, the total pore volume, and the pore volumes in pore diameter ranges of 10 to 16 nm and 8 to 20 nm of the ammonia synthesis catalyst after being used in the ammonia synthesis reaction were determined according to the above method. These results are shown in FIGS. 5 to 10 and Table 2.

TABLE 2

| | | | | Specific | Total | Peak | Pore Volume [cm³/g] | | |
|---|---|---|---|---|---|---|---|---|---|
| | Cerium | Heat Treatment | | Surface | Pore | Pore | Pore | Pore | Ammonia |
| | Oxide | | Temperature | Area | Volume | Diameter | Diameter | Diameter | Concentration |
| | Powder | Atmosphere | [° C.] | [m²/g] | [cm³/g] | [nm] | of 10 to 16 nm | of 8 to 20 nm | [%] |
| Ex. 1 | CeO₂-A | H₂/N₂ | 600 | 92.4 | 0.260 | 9.4 | 0.074 | 0.168 | 0.393 |
| Ex. 2 | CeO₂-A | H₂/N₂ | 625 | 76.7 | 0.243 | 9.4 | 0.113 | 0.184 | 0.415 |
| Ex. 3 | CeO₂-A | H₂/N₂ | 650 | 71.5 | 0.227 | 10.7 | 0.121 | 0.179 | 0.411 |
| Ex. 4 | CeO₂-A | H₂/N₂ | 675 | 58.5 | 0.202 | 12.2 | 0.115 | 0.157 | 0.389 |
| Ex. 5 | CeO₂-B | H₂/N₂ | 650 | 55.5 | 0.195 | 12.2 | 0.123 | 0.149 | 0.394 |
| Comp. Ex. 1 | CeO₂-A | Air | 500 | 104.5 | 0.277 | 7.8 | 0.054 | 0.147 | 0.348 |
| Comp. Ex. 2 | CeO₂-B | Air | 500 | 71.2 | 0.220 | 9.4 | 0.087 | 0.154 | 0.286 |
| Comp. Ex. 3 | CeO₂-B | H₂/N₂ | 725 | 38.0 | 0.181 | 18.5 | 0.033 | 0.092 | 0.316 |
| Comp. Ex. 4 | CeO₂-C | Air | 500 | 33.6 | 0.083 | 3.8 | 0.005 | 0.010 | 0.313 |
| Comp. Ex. 5 | CeO₂-C | H₂/N₂ | 650 | 22.5 | 0.065 | 3.8 | 0.005 | 0.011 | 0.328 |
| Comp. Ex. 6 | CeO₂-D | H₂/N₂ | 650 | 9.4 | 0.042 | 3.5 | 0.007 | 0.013 | 0.157 |
| Comp. Ex. 7 | CeO₂-E | Air | 500 | 47.8 | 0.194 | 50.4 | 0.010 | 0.022 | 0.304 |
| Comp. Ex. 8 | CeO₂-E | H₂/N₂ | 675 | 19.6 | 0.159 | 58.1 | 0.007 | 0.016 | 0.299 |
| Comp. Ex. 9 | CeO₂-F | H₂/N₂ | 675 | 22.3 | 0.170 | 58.1 | 0.010 | 0.019 | 0.329 |

| | | | | | | | |
|---|---|---|---|---|---|---|---|
| Comp. Ex. 10 | PTL 1 | 20.3 | 0.044 | 4.8 | 0.001 | 0.002 | 0.223 |
| Comp. Ex. 11 | PTL 1 | 35.4 | 0.165 | 23.4 | 0.019 | 0.054 | 0.219 |
| Comp. Ex. 12 | NPL 1 | 25.2 | 0.257 | 43.6 | 0.004 | 0.010 | 0.220 |

As shown in FIGS. 5 to 6 and Table 2, by subjecting the catalyst support precursors (CeO₂-A and CeO₂-B) each having a peak pore diameter within a predetermined range to heat treatment in a reducing atmosphere at a predetermined temperature, the pore distribution curves each shifted to the larger pore diameter side with respect to those of the catalyst support precursors, and it was confirmed that catalysts each having a peak pore diameter within a predetermined range were obtained (Examples 1 to 5). On the one hand, when the catalyst support precursors (CeO₂-A and CeO₂-B) were subjected to heat treatment in air at 500° C. (Comparative Examples 1 to 2), although the pore distribution curves each shifted to the larger pore diameter side with respect to those of the catalyst support precursors, the shift widths were smaller than those of the catalysts obtained in Examples 1 to 5, and it was found that the peak pore diameters of the obtained catalysts were also smaller than those of the catalysts obtained in Examples 1 to 5. On the other hand, when the catalyst support precursor (CeO₂-B) was subjected to heat treatment in a reducing atmosphere at 725° C. (Comparative Example 3), the pore distribution curve shifted greatly to the larger pore diameter side with respect to that of the catalyst support precursor, and it was found that the peak pore diameter of the obtained catalyst was also larger than those of the catalysts obtained in Examples 1 to 5.

Further, as shown in Table 2, by subjecting the catalyst support precursors (CeO₂-A and CeO₂-B) each having a pore volume in a pore diameter range of 4 to 16 nm within a predetermined range to heat treatment in a reducing atmosphere at a predetermined temperature, it was confirmed that catalysts in which at least one of the pore volume in the pore diameter range of 10 to 16 nm and the pore volume in the pore diameter range of 8 to 20 nm was within a predetermined range were obtained (Examples 1 to 5). On the one hand, in the catalysts obtained when the catalyst support precursors (CeO₂-A and CeO₂-B) were subjected to heat treatment in air at 500° C. (Comparative Examples 1 to 2), both the pore volume in the pore diameter range of 10 to 16 nm and the pore volume in the pore diameter range of 8 to 20 nm were found to be smaller than a predetermined range. This is considered to be because, as shown in FIGS. 5 to 6, in the catalysts obtained in Comparative Examples 1 to 2, the shift widths of the pore distribution curves to the larger pore diameter side were small, and the number of pores having a predetermined pore diameter was small. Further, even when the catalyst support precursor (CeO₂-B) was subjected to heat treatment in a reducing atmosphere at 725° C. (Comparative Example 3), both the pore volume in the pore diameter range of 10 to 16 nm and the pore volume in the pore diameter range of 8 to 20 nm were found to be smaller than a predetermined range in the obtained catalyst. This is considered to be because, as shown in FIG. 6, the pore distribution curve of the catalyst obtained in Comparative Example 3 excessively shifted to the larger pore diameter side, and the number of pores having a predetermined pore diameter was reduced.

From the above results, it was found that when cerium oxide powder having a peak pore diameter within a predetermined range and a predetermined pore volume within a predetermined range is subjected to heat treatment, by adjusting the heating temperature, the pore diameter distribution and peak pore diameter of the obtained catalyst can be controlled, and a catalyst having a peak pore diameter within a predetermined range and a predetermined pore volume within a predetermined range can be obtained.

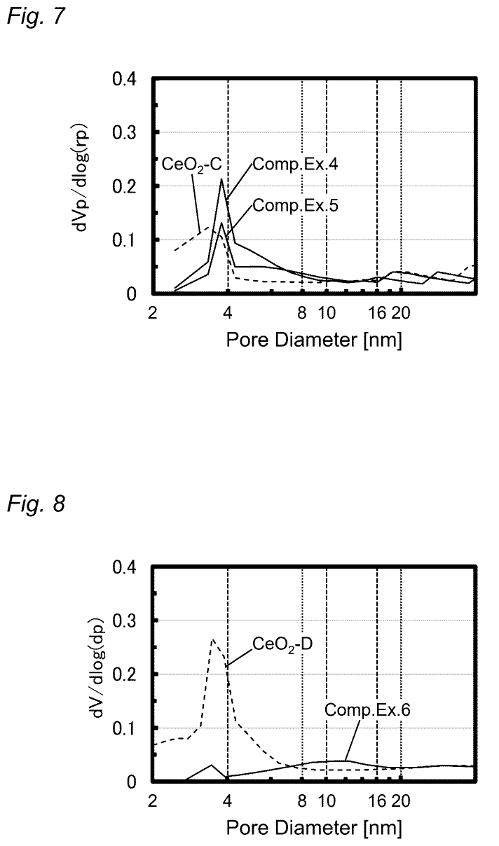

On the other hand, as shown in FIGS. 7 to 8 and Table 2, in the case where the catalyst support precursor (CeO₂-C) having a peak pore diameter smaller than the predetermined range was subjected to heat treatment in air at 500° C. (Comparative Example 4), as well as in the case where the catalyst support precursors (CeO₂-C and CeO₂-D) each having a peak pore diameter smaller than the predetermined range were subjected to heat treatment in a reducing atmosphere at a predetermined temperature (Comparative Examples 5 to 6), the peak pore diameters of the obtained catalysts each hardly change with respect to those of the catalyst support precursors. In addition, it was found that the specific surface areas of the catalysts obtained in Comparative Examples 4 to 6 were extremely smaller than those of the catalyst support precursors. From this result, it was suggested that for the catalyst support precursor having a peak pore diameter smaller than the predetermined range, grain growth occurs significantly during heat treatment or ammonia synthesis.

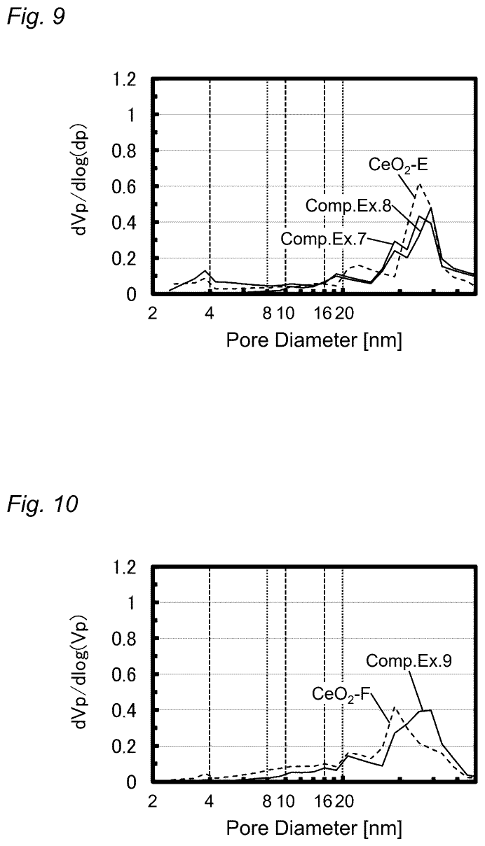

Furthermore, as shown in FIGS. 9 to 10 and Table 2, in the case where the catalyst support precursor (CeO₂-E) having a peak pore diameter larger than the predetermined range was subjected to heat treatment in air at 500° C. (Comparative Example 7), as well as in the case where the catalyst support precursors (CeO₂-E and CeO₂-F) each having a peak pore diameter larger than the predetermined range were subjected to heat treatment in a reducing atmosphere at a predetermined temperature (Comparative Examples 8 to 9), the peak pore diameters of the obtained catalysts each hardly change with respect to those of the catalyst support precursors.

Furthermore, as shown in Table 2, in the case where the catalyst support precursors (CeO₂-C and CeO₂-E) each having a pore volume in the pore diameter range of 4 to 16 nm smaller than a predetermined range were subjected to heat treatment in air at 500° C. (Comparative Example 4 and Comparative Example 7), as well as in the case where the catalyst support precursors (CeO₂-C to CeO₂-F) each having a pore volume in the pore diameter range of 4 to 16 nm smaller than a predetermined range were subjected to heat treatment in a reducing atmosphere at a predetermined temperature (Comparative Examples 5 to 6 and Comparative Examples 8 to 9), both the pore volume in the pore diameter range of 10 to 16 nm and the pore volume in the pore diameter range of 8 to 20 nm were found to be smaller than a predetermined range in each of the obtained catalysts.

From the above results, even if cerium oxide powder having a peak pore diameter smaller than a predetermined range and a predetermined pore volume smaller than a predetermined range, or cerium oxide powder having a peak pore diameter larger than a predetermined range and a predetermined pore volume smaller than a predetermined range is subjected to heat treatment in a reducing atmosphere at a predetermined temperature, the pore diameter distribution hardly changes in the obtained catalyst, and it was found that it is difficult to control the peak pore diameter and the predetermined pore volume to be within a predetermined range.

Furthermore, as shown in Table 2, according to the method described in JP 2021-109130 A (PTL 1), the ammonia synthesis catalyst (Comparative Example 10) prepared using a potassium hydroxide aqueous solution as a precipitant had a peak pore diameter and a predetermined pore volume smaller than predetermined ranges, and the ammonia synthesis catalyst (Comparative Example 11) prepared using an ammonia solution as a precipitant had a peak pore diameter larger than a predetermined range and a predetermined pore volume smaller than a predetermined range. Furthermore, the ammonia synthesis catalyst (Comparative Example 12) prepared according to the method described in Journal of Rare Earths, 2019, Vol. 37, pp. 492-499 (NPL 1) also had a peak pore diameter larger than a predetermined range and a predetermined pore volume smaller than a predetermined range.

### Example 6

Commercially available cerium oxide powder A (CeO₂-A, manufactured by Anan Kasei Co., Ltd.) having the specific surface area and pore characteristics shown in Table 1 was impregnated with an ethanol solution of tetraethyl orthosilicate (manufactured by Tokyo Chemical Industry Co., Ltd.), and then evaporated to dryness at 70° C. The obtained dried product was subjected to heat treatment in a hydrogen (10%)/nitrogen (balance) gas stream at 625° C. for 5 hours to obtain a silicon oxide/cerium oxide composite oxide powder having a silicon content of 10% in terms of atomic ratio (Si/(Ce+Si)×100).

Using this silicon oxide/cerium oxide composite oxide powder as a catalyst support powder, this catalyst support powder was impregnated with an aqueous solution obtained by diluting a nitric acid solution of ruthenium(III) nitrosyl nitrate (Ru(NO)(NO₃)₃ HNO₃ soln, manufactured by Furuya Metal Co., Ltd.) with water, and then evaporated to dryness at 70° C. The obtained dried product was heated in a hydrogen (10%)/nitrogen (balance) gas stream at 300° C. for 2 hours, and then subjected to pressure molding at 160 MPa and crushing treatment to obtain a pelletized ammonia synthesis catalyst (pellet diameter: 0.150 to 0.250 mm) in which 3.07 parts by mass of ruthenium was supported relative to 100 parts by mass of the catalyst support powder. The packing density (pellet density) of this catalyst was 1.51 g/ml.

### Example 7

A zirconium oxide/cerium oxide composite oxide powder having a zirconium content of 10% in terms of atomic ratio (Zr/(Ce+Zr)×100) was obtained in the same manner as in Example 6, except that an aqueous solution of zirconyl nitrate dihydrate (manufactured by FUJIFILM Wako Pure Chemical Corporation) was used instead of the ethanol solution of tetraethyl orthosilicate, and the temperature of the heat treatment was changed to 600° C.

A pelletized ammonia synthesis catalyst (pellet diameter: 0.150 to 0.250 mm) in which 3.00 parts by mass of ruthenium was supported relative to 100 parts by mass of the catalyst support powder was obtained in the same manner as in Example 6, except that this zirconium oxide/cerium oxide composite oxide powder was used as the catalyst support powder. The packing density (pellet density) of this catalyst was 1.55 g/ml.

### Example 8

A magnesium oxide/cerium oxide composite oxide powder having a magnesium content of 15% in terms of atomic ratio (Mg/(Ce+Mg)×100) was obtained in the same manner as in Example 6, except that an aqueous solution of magnesium nitrate hexahydrate (manufactured by FUJIFILM Wako Pure Chemical Corporation) was used instead of the ethanol solution of tetraethyl orthosilicate, and the temperature of the heat treatment was changed to 600° C.

A pelletized ammonia synthesis catalyst (pellet diameter: 0.150 to 0.250 mm) in which 3.11 parts by mass of ruthenium was supported relative to 100 parts by mass of the catalyst support powder was obtained in the same manner as in Example 6, except that this magnesium oxide/cerium oxide composite oxide powder was used as the catalyst support powder. The packing density (pellet density) of this catalyst was 1.49 g/ml.

### Example 9

A lanthanum oxide/cerium oxide composite oxide powder having a lanthanum content of 5% in terms of atomic ratio (La/(Ce+La)×100) was obtained in the same manner as in Example 6, except that an aqueous solution of lanthanum (III) nitrate hexahydrate (manufactured by FUJIFILM Wako Pure Chemical Corporation) was used instead of the ethanol solution of tetraethyl orthosilicate, and the temperature of the heat treatment was changed to 600° C.

A pelletized ammonia synthesis catalyst (pellet diameter: 0.150 to 0.250 mm) in which 3.08 parts by mass of ruthenium was supported relative to 100 parts by mass of the catalyst support powder was obtained in the same manner as in Example 6, except that this lanthanum oxide/cerium oxide composite oxide powder was used as the catalyst support powder. The packing density (pellet density) of this catalyst was 1.51 g/ml.

### Example 10

An aluminum oxide/cerium oxide composite oxide powder having an aluminum content of 5% in terms of atomic ratio (Al/(Ce+Al)×100) was obtained in the same manner as in Example 6, except that an aqueous solution of aluminum nitrate nonahydrate (manufactured by FUJIFILM Wako Pure Chemical Corporation) was used instead of the ethanol solution of tetraethyl orthosilicate, and the temperature of the heat treatment was changed to 600° C.

A pelletized ammonia synthesis catalyst (pellet diameter: 0.150 to 0.250 mm) in which 3.18 parts by mass of ruthenium was supported relative to 100 parts by mass of the catalyst support powder was obtained in the same manner as in Example 6, except that this aluminum oxide/cerium oxide composite oxide powder was used as the catalyst support powder. The packing density (pellet density) of this catalyst was 1.46 g/ml.

### Example 11

A zirconium oxide/cerium oxide composite oxide powder was obtained in the same manner as in Example 7, except that an aqueous solution of zirconyl nitrate dihydrate was impregnated so that the zirconium content was 5% in terms of atomic ratio (Zr/(Ce+Zr)×100).

Using this zirconium oxide/cerium oxide composite oxide powder as a catalyst support powder, this catalyst support powder was impregnated with an aqueous solution obtained by diluting a nitric acid solution of ruthenium(III) nitrosyl nitrate (Ru(NO)(NO₃)₃ HNO₃ soln, manufactured by Furuya Metal Co., Ltd.) with water, and then evaporated to dryness at 70° C. The obtained dried product was subjected to heat treatment in a hydrogen (10%)/nitrogen (balance) gas stream at 300° C. for 2 hours. Further, the obtained powder was impregnated with an aqueous solution of potassium nitrate (manufactured by FUJIFILM Wako Pure Chemical Corporation), and then evaporated to dryness at 110° C. for 2 hours. The obtained dried product was subjected to pressure molding at 160 MPa and crushing treatment to obtain a pelletized ammonia synthesis catalyst (pellet diameter: 0.150 to 0.250 mm) in which 3.12 parts by mass of ruthenium relative to 100 parts by mass of the catalyst support powder and potassium having an atomic ratio of 1.0 relative to ruthenium were supported. The packing density (pellet density) of this catalyst was 1.53 g/ml.

### Ammonia Synthesis Reaction

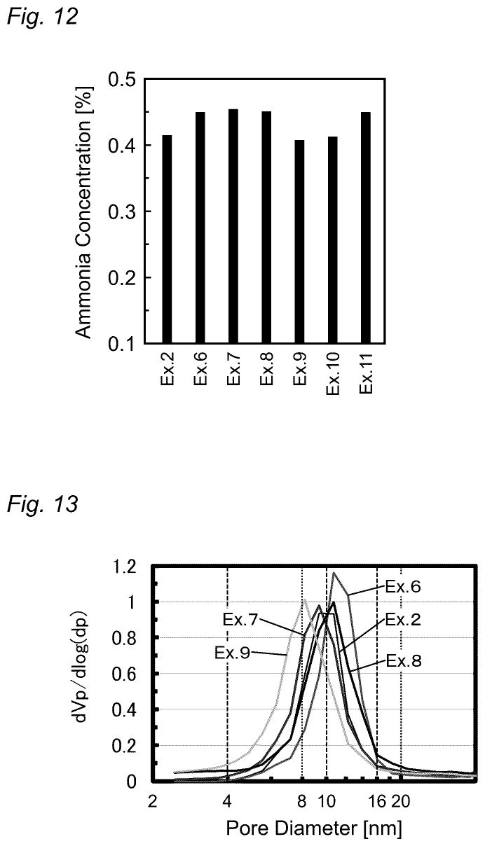

An ammonia synthesis reaction was performed according to the above method, except that the ammonia synthesis catalysts obtained in Examples 6 to 11 were used. One hour after the start of the synthesis reaction, the ammonia concentration of the catalyst outlet gas was measured using a Fourier transform infrared (FT-IR) spectrometer installed at the outlet of the reactor. The results are shown in Table 3 and FIG. 12.

### Measurement of Specific Surface Area and Pore Characteristics of Ammonia Synthesis Catalyst

The specific surface area, the pore distribution curve, the peak pore diameter, the total pore volume, and the pore volumes in pore diameter ranges of 10 to 16 nm and 8 to 20 nm of the ammonia synthesis catalyst after being used in the ammonia synthesis reaction were determined according to the above method. These results are shown in FIG. 13 and Table 3.

TABLE 3

| | | | | Specific | Total | Peak | Pore Volume [cm³/g] | | Ammonia |
|---|---|---|---|---|---|---|---|---|---|
| | Cerium Oxide | Composited Metal Oxide | | Surface Area | Pore Volume | Pore Diameter | Pore Diameter | Pore Diameter | Concentration |
| | Powder | Type | Atomic Ratio [%] | [m²/g] | [cm³/g] | [nm] | of 10 to 16 nm | of 8 to 20 nm | [%] |
| Ex. 2 | CeO₂-A | — | 0 | 76.7 | 0.243 | 9.4 | 0.113 | 0.184 | 0.415 |
| Ex. 6 | CeO₂-A | SiO₂ | 10 | 79.1 | 0.261 | 10.7 | 0.171 | 0.215 | 0.449 |
| Ex. 7 | CeO₂-A | ZrO₂ | 10 | 105.4 | 0.303 | 9.4 | 0.102 | 0.188 | 0.454 |
| Ex. 8 | CeO₂-A | MgO | 15 | 75.6 | 0.255 | 10.7 | 0.147 | 0.197 | 0.451 |
| Ex. 9 | CeO₂-A | La₂O₃ | 5 | 114.3 | 0.319 | 8.2 | 0.069 | 0.163 | 0.408 |
| Ex. 10 | CeO₂-A | Al₂O₃ | 5 | 97.3 | 0.300 | 10.7 | 0.133 | 0.213 | 0.413 |
| Ex. 11 | CeO₂-A | ZrO₂ | 5 | 54.4 | 0.262 | 12.2 | 0.125 | 0.179 | 0.449 |

As shown in FIG. 13, it was confirmed that when silicon oxide (Example 6) or magnesium oxide (Example 8) was composited with CeO₂-A, the peak of the pore distribution curve shifted to the larger pore diameter side; and when zirconium oxide (Example 7) or lanthanum oxide (Example 9) was composited with CeO₂-A, the peak of the pore distribution curve shifted to the smaller pore diameter side. In addition, in any case where the metal oxide was composited, it was confirmed that the peak of the pore distribution curve was slightly higher and wider than that of CeO₂-A. This indicates that the pore volume having a pore diameter near the peak increased.

In addition, as shown in Table 3, when each of the metal oxides, namely silicon oxide (Example 6), zirconium oxide (Examples 7 and 11), magnesium oxide (Example 8), lanthanum oxide (Example 9), or aluminum oxide (Example 10) was composited with CeO₂-A, catalysts in which at least one of the pore volume in the pore diameter range of 10 to 16 nm and the pore volume in the pore diameter range of 8 to 20 nm was within a predetermined range were obtained, and in particular, when each of the metal oxides, namely silicon oxide, zirconium oxide, magnesium oxide, or aluminum oxide was composited, it was confirmed that catalysts in which both the pore capacity in the pore diameter range of 10 to 16 nm and the pore capacity in the pore diameter range of 8 to 20 nm were within predetermined ranges were obtained (Examples 6 to 8 and 10 to 11).

Furthermore, the ammonia synthesis catalysts obtained in Examples 6 to 8 and 10 had a larger pore volume in the pore diameter range of 8 to 20 nm than the ammonia synthesis catalysts obtained in Examples 1 to 4. In addition, the ammonia synthesis catalysts obtained in Examples 6, 8, and 10 had a larger pore volume in the pore diameter range of 10 to 16 nm than the ammonia synthesis catalysts obtained in Examples 1 to 4.

From the above results, in the catalyst support including cerium oxide, it was found that composite formation with silicon oxide, zirconium oxide, magnesium oxide, or aluminum oxide is effective for increasing the pore volume in the pore diameter range of 8 to 20 nm, and composite formation with silicon oxide, magnesium oxide, or aluminum oxide is effective for increasing the pore capacity in the pore diameter range of 10 to 16 nm.

As shown in Tables 2 to 3 and FIGS. 11 to 12, the catalysts (Examples 1 to 11) each having a peak pore diameter within a predetermined range and a predetermined pore volume within a predetermined range were confirmed to have a higher ammonia concentration of catalyst outlet gas and be superior in ammonia synthesis activity than the catalysts (Comparative Examples 1 to 12) each having a predetermined pore volume smaller than a predetermined range.

Furthermore, the ammonia synthesis catalysts obtained in Examples 6 to 8 and 10 were confirmed to have a higher ammonia concentration of catalyst outlet gas and be superior in ammonia synthesis activity than the ammonia synthesis catalysts obtained in Examples 1 to 5. From this, it was found that, in the ammonia synthesis catalyst containing cerium oxide as a catalyst support, the composite formation with silicon oxide, zirconium oxide, magnesium oxide, or aluminum oxide is very effective in improving the ammonia synthesis activity.

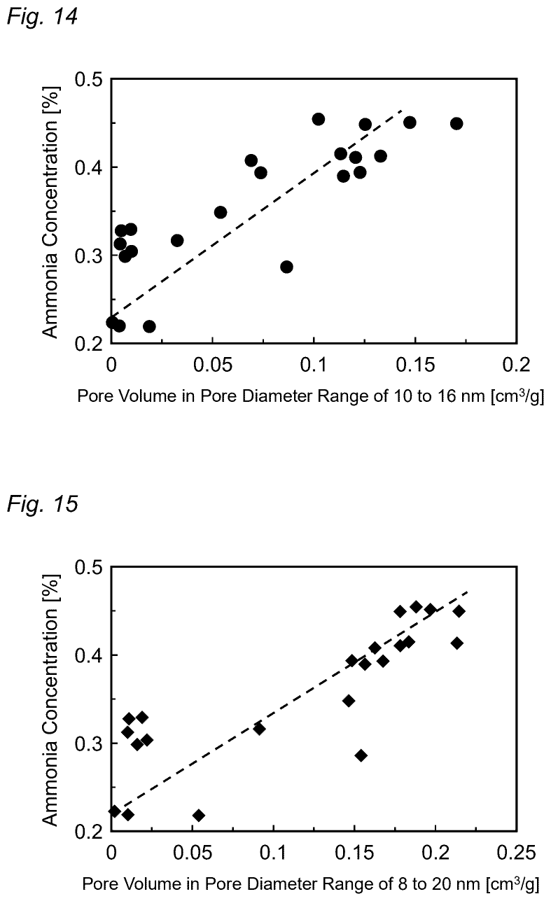

Based on the results shown in Tables 2 and 3, the ammonia concentration of the catalyst outlet gas was plotted against each of the pore volume in the pore diameter range of 10 to 16 nm and the pore volume in the pore diameter range of 8 to 20 nm. The results are shown in FIGS. 14 and 15.

As shown in FIGS. 14 and 15, it was found that the pore volume has a correlation with the ammonia concentration in a relatively wide range, and in particular, the pore volume in the pore diameter range of 8 to 20 nm has a high correlation with the ammonia concentration. Furthermore, the ammonia concentration and the pore volume show a high correlation in a region where the pore volume in the pore diameter range of 10 to 16 nm is 0.10 cm³/g or more, or in a region where the pore volume in the pore diameter range of 8 to 20 nm is 0.16 cm³/g or more; therefore, in the ammonia synthesis catalyst of the present invention, it is considered that the pore structure in the pore diameter range of 10 to 16 nm or the pore structure in the pore diameter range of 8 to 20 nm contributes to the expression of high ammonia synthesis activity.

### INDUSTRIAL APPLICABILITY

As described above, according to the present invention, it becomes possible to obtain an ammonia synthesis catalyst excellent in ammonia synthesis activity. Therefore, since the method for synthesizing ammonia of the present invention can efficiently synthesize ammonia, it has high energy efficiency, and is useful for producing ammonia used as, for example, an energy carrier for hydrogen energy.

1. An ammonia synthesis catalyst comprising a catalyst support including cerium oxide and ruthenium supported on the catalyst support,
wherein a peak pore diameter is in a range of 8 to 16 nm, and a pore volume in a pore diameter range of 10 to 16 nm is 0.10 cm³/g or more, and/or a pore volume in a pore diameter range of 8 to 20 nm is 0.16 cm³/g or more, as measured by a Barrett-Joyner-Halenda (BJH) method.

2. The ammonia synthesis catalyst according to claim 1, wherein a pore volume in a pore diameter range of 10 to 16 nm is 0.10 cm³/g or more, and a pore volume in a pore diameter range of 8 to 20 nm is 0.16 cm³/g or more, as measured by the BJH method.

3. The ammonia synthesis catalyst according to claim 1, wherein the catalyst support further contains at least one metal oxide selected from the group consisting of silicon oxide, zirconium oxide, magnesium oxide, lanthanum oxide, and aluminum oxide.

4. The ammonia synthesis catalyst according to claim 1, wherein an alkali metal is further supported on the catalyst support.

5. A method for producing an ammonia synthesis catalyst, comprising the steps of:
obtaining a catalyst support by subjecting a catalyst support precursor including cerium oxide to heat treatment in a reducing atmosphere at 600 to 700° C. for 5 hours or more, wherein the catalyst support precursor has a peak pore diameter in a range of 4 to 16 nm and a pore volume in a pore diameter range of 4 to 16 nm of 0.16 cm³/g or more, as measured by a Barrett-Joyner-Halenda (BJH) method after calcination in air at 500° C. for 5 hours or more; and
supporting ruthenium on the catalyst support.

6. The method for producing an ammonia synthesis catalyst according to claim 5, wherein the catalyst support precursor has a pore volume in a pore diameter range of 10 to 16 nm of less than 0.10 cm³/g and a pore volume in a pore diameter range of 8 to 20 nm of less than 0.16 cm³/g, as measured by the BJH method after calcination in air at 500° C. for 5 hours or more.

7. The method for producing an ammonia synthesis catalyst according to claim 5, wherein the heating temperature of the catalyst support precursor is 625 to 650° C.

8. The method for producing an ammonia synthesis catalyst according to claim 5, further comprising a step of preparing the catalyst support precursor by impregnating cerium oxide with a solution containing at least one metal compound selected from the group consisting of a silicon compound, a zirconium compound, a magnesium compound, a lanthanum compound, and an aluminum compound.

9. The method for producing an ammonia synthesis catalyst according to claim 5, further comprising supporting an alkali metal on the catalyst support.

10. A method for synthesizing ammonia, comprising contacting a gas containing hydrogen and nitrogen with the ammonia synthesis catalyst according to claim 1 to synthesize ammonia.

11. The ammonia synthesis catalyst according to claim 2, wherein the catalyst support further contains at least one metal oxide selected from the group consisting of silicon oxide, zirconium oxide, magnesium oxide, lanthanum oxide, and aluminum oxide.

12. The ammonia synthesis catalyst according to claim 2, wherein an alkali metal is further supported on the catalyst support.

13. The ammonia synthesis catalyst according to claim 3, wherein an alkali metal is further supported on the catalyst support.

14. The method for producing an ammonia synthesis catalyst according to claim 6, wherein the heating temperature of the catalyst support precursor is 625 to 650° C.

15. The method for producing an ammonia synthesis catalyst according to claim 6, further comprising a step of preparing the catalyst support precursor by impregnating cerium oxide with a solution containing at least one metal compound selected from the group consisting of a silicon compound, a zirconium compound, a magnesium compound, a lanthanum compound, and an aluminum compound.

16. The method for producing an ammonia synthesis catalyst according to claim 7, further comprising a step of preparing the catalyst support precursor by impregnating cerium oxide with a solution containing at least one metal compound selected from the group consisting of a silicon compound, a zirconium compound, a magnesium compound, a lanthanum compound, and an aluminum compound.

17. The method for producing an ammonia synthesis catalyst according to claim 6, further comprising supporting an alkali metal on the catalyst support.

18. The method for producing an ammonia synthesis catalyst according to claim 7, further comprising supporting an alkali metal on the catalyst support.

19. The method for producing an ammonia synthesis catalyst according to claim 8, further comprising supporting an alkali metal on the catalyst support.
